(19) United States
(12) Patent Application Publication
(10) Pub. No.: US 2011/0011299 A1
(43) Pub. Date: Jan. 20, 2011

(54) INTERNAL CONDUIT VEHICLE AND METHOD FOR PERFORMING OPERATIONS IN A PIPELINE

(75) Inventor: Esben Beck, Fjellhamar (NO)

Correspondence Address: DENNISON, SCHULTZ & MACDONALD, 1727 KING STREET, SUITE 105, ALEXANDRIA, VA, 22314, US

(73) Assignee: HELIX TECHNOLOGIES AS, Kjeller (NO)

(21) Appl. No.: 12/812,095

(22) PCT Filed: Jan. 23, 2009
(86) PCT No.: PCT/NO2009/000029

§ 371 Date: Sep. 2, 2010

(30) Foreign Application Priority Data
Jan. 25, 2008 (NO) 20080478

(51) Int. Cl. F16L 55/18; F16L 55/28

(52) U.S. Cl. 104/138.2

(57) ABSTRACT

An internal conduit vehicle, also called a pipeline vehicle. The vehicle includes first and second wheel assemblies that are rotated in opposite directions to move the vehicle along the pipeline, or that are mutually independent to perform a more complex movement. Each wheel assembly includes a number of wheels at the free end of wheel arms, each wheel having a spin axis that is angled in respect of an axis of the chassis. Each wheel is shaped as a rotation symmetric body with a large end and a small end, and is unilaterally mounted to a wheel arm by the large end.

### FIELD OF THE INVENTION

The present invention relates to an internal conduit vehicle, also called a pipeline tractor or pipeline vehicle, which is a device travelling inside a pipeline transporting measuring instruments and tools. Such devices are in particular in use in the oil and gas industry, but may also find use in other fields, such as for inspecting and cleaning water pipes, sewers or ventilation tubes. According to a second aspect the present invention relates to a method for performing operations in a pipeline by use of a pipeline vehicle.

### BACKGROUND

Several varieties of pipeline vehicles have been made in the past based on different technologies. Some use the fluid flowing in the pipeline for propulsion (pigs) or move along with worm-like movements. Others use wheels or belts for moving along the pipeline.

From U.S. Pat. No. 5,551,349 to Bodzin there is known a pipeline vehicle comprising two coaxially aligned wheel assemblies mounted to each end of a chassis. Each wheel assembly includes a number of elongate rollers (wheels) positioned at an angle around a hub. The rollers are suspended in both ends by a spring arrangement pressing the rollers against the pipeline wall. The rollers in each wheel assembly are angled in opposite directions, and are rotated by motors inside the chassis in opposite directions. This creates a translatory movement inside the pipeline.

Current pipeline vehicles have a number of shortcomings: One is that they have a rather low traction force, mainly due to the small footprint of the wheels against the wall. This means that they may perform well in horizontal pipelines, but have a very limited ability of climbing steep pipelines. This also means that they may only carry very limited work loads, i.e. they cannot drag heavy tools or cables along a pipeline. Another shortcoming is that they are very restricted when it comes to passing bends or T-sections in a pipeline, in that the elements bearing the wheels may get blocked against the different angles or departing walls.

### OBJECTIVES

It is an object of the present invention to provide an internal conduit vehicle that may travel along steep ranges in a pipeline.

Another object is to provide a vehicle which may pass through sharp bends or pass T-bends without blocking.

Yet another object is to provide a vehicle that travels faster and with a higher degree of accuracy than existing units.

It is still another object to provide a vehicle that, relative to its size, provides a higher drag-force capacity and even provides features of interpolation.

### SUMMARY OF THE INVENTION

This is achieved in an internal conduit vehicle as claimed in claim 1.

According to a second aspect the invention provides a method for performing operations in a pipeline vehicle as defined by claim 19.

Preferred embodiments of the invention are disclosed by the dependent claims.

According to the invention, the vehicle is equipped with rotation-symmetric wheels with a big and a small end, i.e. being cone or cup-shaped, which are mounted on wheel arms in their big ends.

Advantageous embodiments of the invention include wheels made of a soft material with elastic properties and the assembly of two wheels back-to-back on each wheel arm.

By “free end of a wheel arm” in the sense used herein is meant as the end of the wheel arm not attached to the hub, i.e. the end at which the wheel(s) are attached. By “plurality” in the sense used herein is meant more than one.

### BRIEF DESCRIPTION OF THE DRAWINGS

The invention will now be described in detail in reference to the appended drawings, in which:

FIG. 1 is a perspective drawing showing a pipeline vehicle according to the present invention,

FIG. 2 shows a perspective view of another embodiment of a pipeline vehicle according to the present invention.

FIG. 3 shows the vehicle of FIG. 1 with one wheel removed, to show details of the mounting hardware,

FIG. 4 shows an imaginary surface enveloping vehicle according to the embodiment of the invention shown in FIG. 1,

FIG. 5 illustrates a vehicle passing a T-branch in a pipeline.

FIG. 6 shows three alternative detail designs of wheels suitable for all embodiments of the pipeline vehicle according to the present invention.

FIGS. 7a and 7b show, in two situations, functionality of wheel arm and wheel for a particular embodiment of the pipeline vehicle according to the present invention.

### DETAILED DESCRIPTION

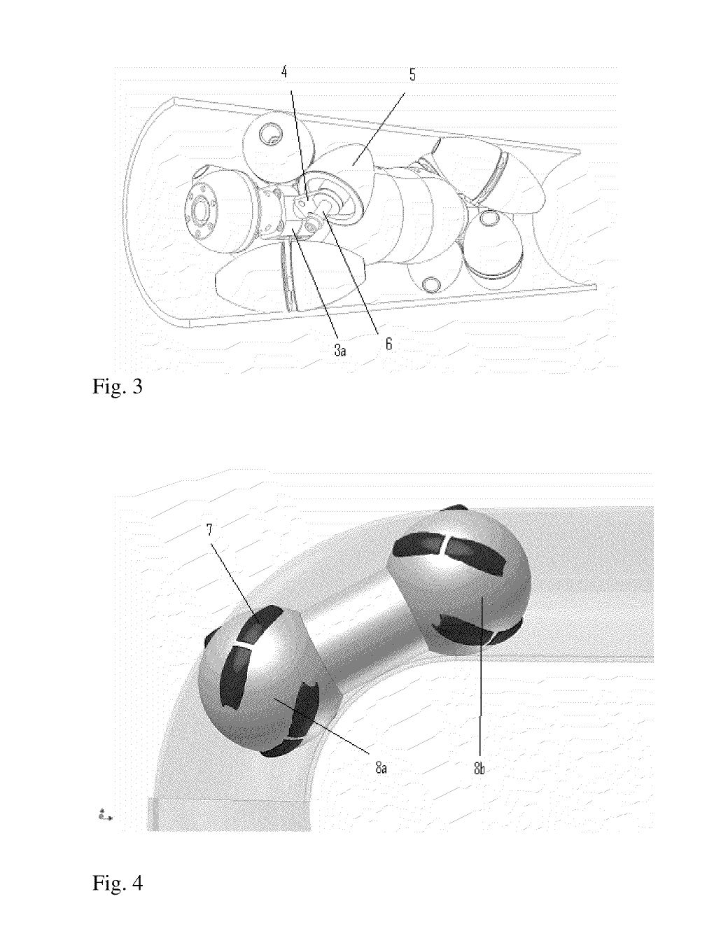

FIG. 1 shows an embodiment of the invention when passing a bend in a pipeline. The vehicle includes a chassis 1 with a first wheel assembly 2a mounted in one end and a second wheel assembly 2b mounted in the other end. Each wheel assembly 2a, b includes a hub 3a, b (FIG. 3) carrying a number of wheel arms 4 protruding as spokes from each hub. On each wheel arm 4 there is mounted at least one freely rotating wheel 5. Motor drives inside the chassis are adapted to rotate the wheel assemblies in counteracting directions to propel the vehicle along the pipe.

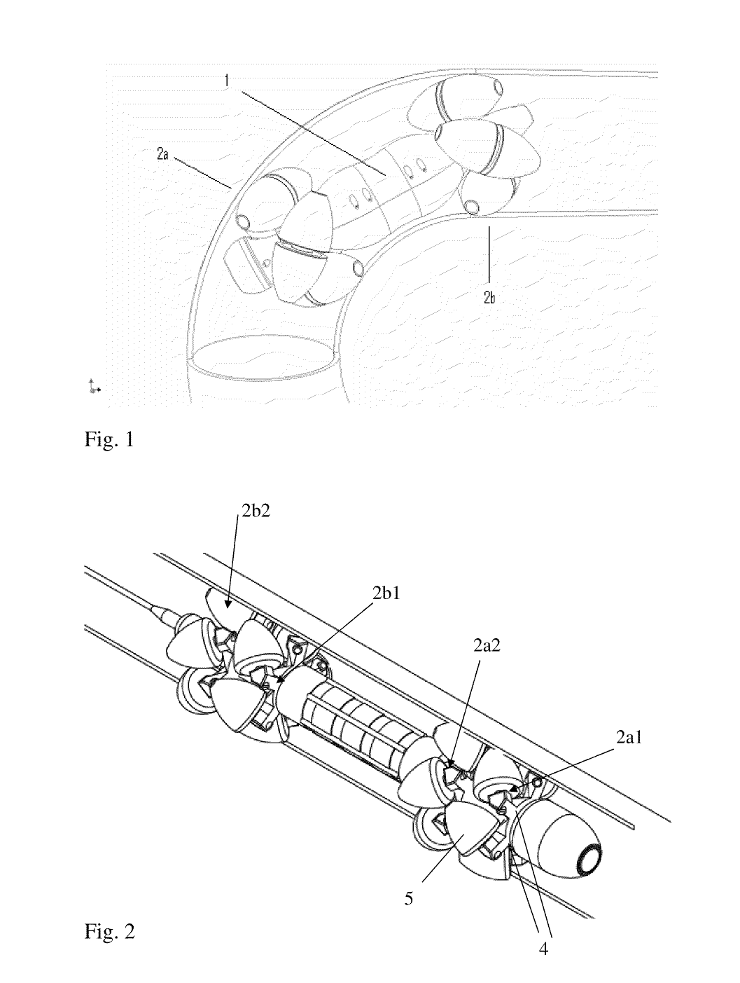

Each wheel 5 is a rotation symmetric body with a small end and a big end. This means that the wheel may be shaped e.g. as a truncated cone, a half ellipsoid or cup. The wheels shown in FIG. 2 are shaped as half-ellipsoid cups. This particular design of the wheels, which are preferably made from an elastic material, acts to distribute the pressure increasing the footprint on the pipe wall, but in a gentle way preventing damages on the pipe.

In FIG. 1, each wheel assembly is shown with two wheels 5 mounted in pairs on each wheel arm 4, in back-to-back fashion, i.e. the big ends of the wheels of each pair facing each other. This way of mounting the wheels will be an advantage when going through bends in the pipeline, as there is no mounting hardware at the small end of each wheel that may touch the pipeline wall. As shown in FIG. 1 there is one wheel assembly 2a/2b at each end of the vehicle. Even in this embodiment each one of any two wheels (“twins”) of a pair of wheels, mounted back to back on any given wheel arm is free to rotate around its respective pin 6 independent of the rotation of its twin. When travelling in straight pipeline sections the rotation speed of each one of “twin wheels” will be approximately the same, while going in curves the rotation of each twin wheel may vary independently.

As best seen in FIG. 3, the wheels 5 are mounted on pins 6 protruding from each wheel arm 4 and each wheel 5 is separately free to spin around its respective pin 6. The wheels 5 may be fastened to the wheel arms 4 or pins 6 by means of a quick release mechanism. As an alternative, such a quick release mechanism may be connecting the wheel arms to the hub or the hub to a powering means, such as a motor drive axis. Such a mechanism will be handy in the field as the operator may have to change wheels to suit the conditions encountered, such as different pipe diameters, if there are sharp bends in the pipeline, or if the pipeline wall is covered by some slippery growth.

FIG. 2 shows an embodiment for which the vehicle is provided with only one wheel mounted on each wheel arm. In this embodiment there are two wheel assemblies 2a1 and 2a2 at the front end of the vehicle, typically operating with mutually opposite rotation and there are two wheel assemblies 2b1 and 2b2 at the rear end of the vehicle, typically operating with mutually opposite rotation. The “double” set of wheel assemblies is not a requirement in the case of one wheel per wheel arm, but provides a higher traction force and is therefore preferred for some applications. A person skilled in the art will understand that double set of wheel assemblies requires double set of hubs, one partially enveloping the other.

The number of wheel arms on a wheel assembly may vary in accordance to the size (diameter) of the pipeline, the particular application, the number of wheel assemblies on the vehicle, etc. Generally there are at least two wheel arms on a wheel assembly and rarely more than twelve. Three to six wheel arms per wheel assembly is usually preferred.

When the vehicle according to the present invention is to be used in a pipeline with sharp bends, the wheel assemblies should be given a particular design in which an imaginary envelope circumscribing the wheels is shaped as a more compact ellipsoid, or a sphere. It should be noted that a sphere is in fact a special case of an ellipsoid. In case the vehicle is to be used in fairly straight stretches only, the “envelope” may be cylindrical or close to cylindrical. In the general case, the wheel “envelope” may be said to have an ellipsoidal shape. It is to be noted that this imaginary envelope is circumscribing the wheels when they are pressed against the pipeline wall and their shape has been deformed accordingly.

This is illustrated in FIG. 4. The black areas 7 are the footprints or surface areas occupied by each wheel on the pipeline wall. The grey balls are the imaginary envelopes circumscribing each wheel assembly 2a, b.

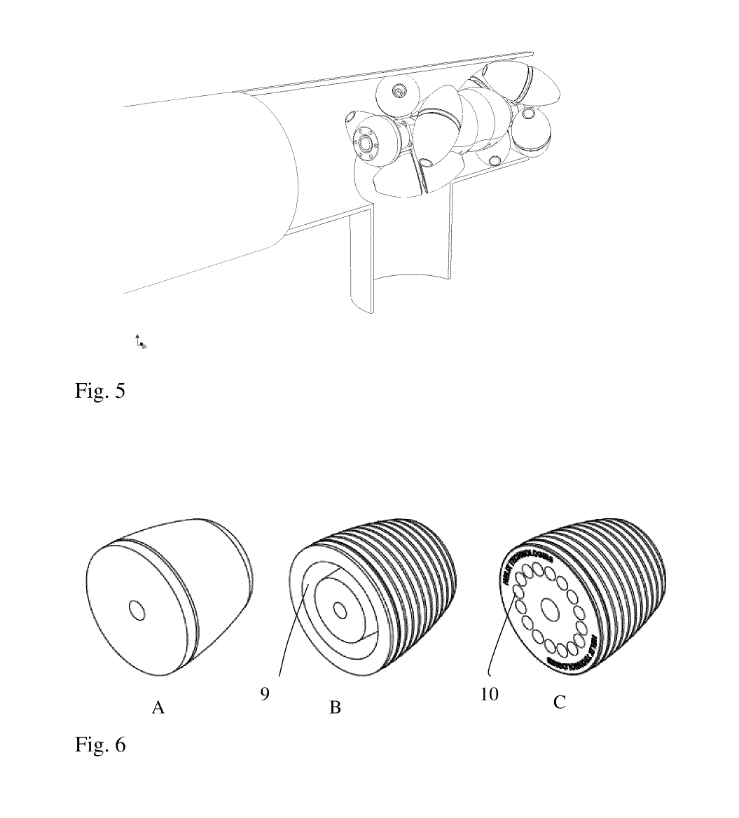

FIG. 5 illustrates that the inventive pipeline vehicle has the ability to pass a T without becoming stuck. This is due to the particular distribution of contact points on the pipe wall. As mentioned earlier wheels on one and the same wheel arm may at least temporarily exhibit different rotational speed, and when passing a T, one wheel of a twin pair could even temporarily come to rest (not having contact with the pipe wall) while the other wheel on the same wheel arm is still rotating.

To achieve desired properties, the wheels are preferably made from an elastic material, such as an elastic polymer material. This polymer material could be foamy. The material could also be a composite with reinforcing fibres. Alternatively or additionally the wheels may include materials suitable to affect the mechanical properties of the wheels, like friction, strength and wear resistance. One non-limiting example is to include small, hard particles to increase the friction against certain surfaces. Such particles could be of any suitable materials, like metal, metal oxides, and crushed nutshell to name a few.

FIG. 6 shows three different wheel designs which are all useful for all embodiments of the pipeline vehicle of the present invention. The wheel A is substantially compact and has a rather smooth surface. Wheel B is provided with an annular recess 9 that contributes to the deformable properties of the wheel, i.e. it is desirably weakened to allow a higher degree of deformation when subjected to pressure. Its outer surface is provided with grooves. Other patterns than grooves may also be applied e.g. to increase the friction against the pipeline wall. Wheel C has similarities with wheel B, but has a number of discrete holes 10 instead of the annular recess 9 to enhance the deformable properties. Also wheel C has grooves in its outer surface to improve its mechanical characteristics, in particular with regard to friction. A design not shown could be one with spokes, which in principle would be quite similar to design C except that the holes could have a profile deviating from a circular hole. In general terms wheels of the vehicle according to the present invention may preferably include at least one cavity around its spin axis.

When deformed, the wheels will obtain a large footprint against the pipeline wall. Due to the large footprint, each wheel may contribute a large traction force to the pipeline wall.

With this propulsion method, the pressure against the sidewall will increase in proportion with the need for traction force. Even though the available traction force will be increased compared with prior art pipeline vehicles, the soft wheels will prevent damages on the pipe wall.

Another benefit from this type of wheel is that given the higher footprint, they will require less pre-tension against the pipe inner wall. In turn, this will reduce the total amount of energy required to drive the vehicle.

To further increase the flexibility of the vehicle, each wheel arm may be resilient, e.g. formed as a flat spring. Alternatively, each arm may be hinged to the hub, and loaded with a spring, and/or each wheel may be connected to the arm in a spring mount.

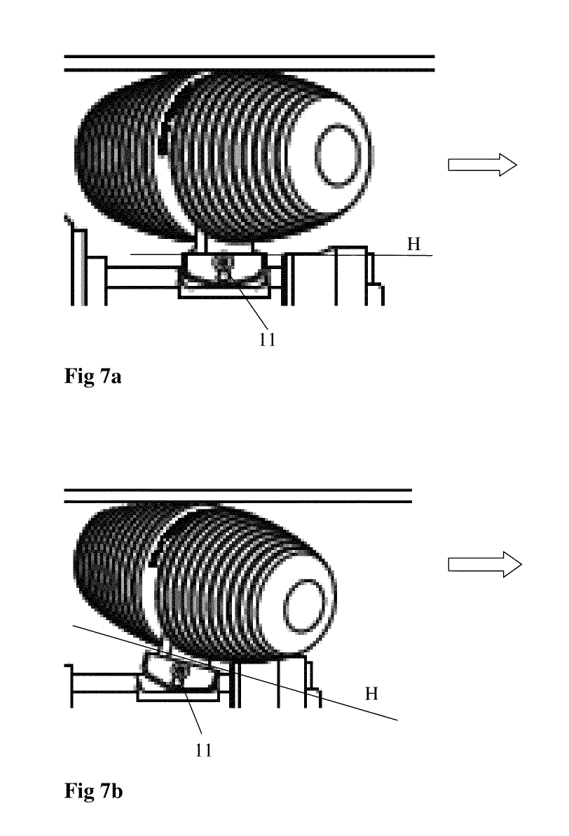

In a preferred variant, see FIG. 7, the wheel arm design comprises a pivotal joint 11 allowing the wheel arm 4 a freedom of movement (tilt) in a defined direction. When designed appropriately, this freedom of movement will not negatively affect the vehicle's ability to move. In a situation where the vehicle is travelling in the absence of any heavy load, the wheel arms will exhibit insignificant or little tilt as shown by FIG. 7a. We particularly draw the attention to the help line “H” which in 7a is parallel with the pipeline wall above. The direction of movement is to the right.

In FIG. 7b is shown a situation where a heavy load is pulled behind the vehicle, the direction of movement still being to the right. The wheel arm 4 is now significantly tilted and the rear wheel of each pair of wheels is correspondingly forced against the pipeline wall with increased pressure compared to the situation in FIG. 7a. The more the load pulls on the vehicle, the larger the tilt of the wheel arms and the larger the frictional grip between the wheels and the pipeline wall. With an appropriate design and size of the vehicle and wheels and with an appropriate hardness/elasticity of the wheels, the wheels themselves will push the wheel arms back to neutral position when the pulling action is terminated. There is thus no need for a spring to hold or (re)position the wheel arms.

In case the pipeline vehicle according to the present invention should get stuck in a pipeline, either in a bend or in other obstructions, it is preferable that at least some of the wheel arms are provided with a “weak link”, a shear pin or the like, that will give way at a certain level of backwards pulling force, thus allowing the vehicle to be pulled out by force. It is most preferred that the weak link is designed in a manner not leaving loose parts in the pipeline, e.g. by allowing the arms to fold, not to break, when the mentioned pulling force is applied. In embodiments in which the wheel arms are provided with a hinge, the weak link may have the form of at least one shear pin at one or more links to allow the arm(s) in question to be folded against the chassis e.g. when pulling the umbilical cable with a force exceeding the strength of the shear pin(s).

In preferred embodiments of the invention the vehicle include means for interpolation, i.e. each wheel assembly may be controlled individually, e.g. by a computer, to allow the vehicle to move according to a predetermined pattern. Such a pattern could be a simple turn around its length axis, a combination of axial and rotational movement such as, but not limited to, rotational movement around its length axis in combination with a back and forth movement so as to “draw” a defined geometric curve on the inside of the tubing in which it is located. Relevant applications involving interpolation include, but is not limited to, applications involving inspection or maintenance within a pipeline, utilizing unit operations such as welding, brazing, gluing, drilling, sawing, screwing, polishing, flushing and the like. A person skilled in the art would recognize that in order to be able to perform such operations, the vehicle would have to be provided with tools suited therefore, such tools not being part of the present invention. Any tools suitable for the purpose can be used provided that it allows remote operation and that it fits within the pipeline.

In the embodiment shown in FIG. 1, the arms are mounted rigid on the wheel hub, i.e. providing the wheels with a fixed angle in respect of the axis of the chassis (and pipeline). This angle determines the gear ratio of the device, i.e. the speed per revolution of the wheel assembly and the traction force (or rather the traction moment).

In a further embodiment of the invention, the wheel arm is rotatably mounted on the hub. Then, the arm may be free to rotate through a limited angle, and adjust itself to the pipe. In addition or as an alternative to this the spin axis angle of the wheels may be made adjustable, either by using a suitable mechanical mount allowing the operator to provide the wheels with a proper angle for the task in question before the device is launched into the pipeline, or by incorporating a remotely operated motor drive in the hub allowing the angle to be adjusted when the device is travelling along the pipeline.

The pipeline vehicle according to the present invention does not require separate adjustment possibilities like springs or the like, thus allowing a very robust construction. The elastic material of the wheels will absorb diameter or surface variations of the walls of the pipeline.

1. An internal conduit vehicle comprising
a chassis (1) having a length axis,
a first wheel assembly (2a) mounted in a first end of said chassis (1),
a second wheel assembly (2b) mounted in a second end of said chassis (1),
each wheel assembly (2a, 2b) including a number of wheels (5), each wheel (5) having a spin axis that is angled in respect of the length axis of the chassis (1),
rotation means for rotating said first and second wheel assemblies in mutually independent directions, characterized in
each wheel (5) being shaped as a rotation symmetric body with a big end and a small end,
each wheel (5) being unilaterally mounted in its big end on a wheel arm (4).

2. A vehicle as claimed in claim 1, wherein each wheel assembly (2) comprises a plurality of wheel arms (4) attached by a hub (3) to longitudinally oriented rotation means and extending radially therefrom, the free end of each wheel arm (4) being provided with at least one wheel (5) rotatably attached to the wheel arm (4) by a pin (6).

3. A vehicle as claimed in claim 2, wherein there are two wheel assemblies (2a1, 2a2 resp 2b1, 2b2) at each end of the vehicle and one wheel (5) attached to each wheel arm (4).

4. A vehicle as claimed in claim 2, wherein there is one wheel assembly (2a resp. 2b) at each end of the vehicle and two wheels (5) attached to each wheel arm (4), the big ends of said two wheels facing each other.

5. A vehicle as claimed in claim 1, wherein at least one wheel arm (4) of each wheel assembly (2a, 2b) is provided with a pivotal joint (11) allowing the free end of the wheel arm freedom of movement.

6. A vehicle as claimed in claim 4, wherein the wheels (5) are arranged in each wheel assembly (2a, 2b) so that the generatrices of the wheels (5) may be circumscribed by an imaginary elliptical envelope.

7. A vehicle as claimed in claim 1, wherein the wheels (5) are made in a flexible material with inherent elastic properties.

8. A vehicle as claimed in claim 7, wherein the wheels (5) include a core and an outer layer made of materials with different mechanical characteristics.

9. A vehicle as claimed in claim 7, wherein the wheels (5) include at least one cavity (9, 10) around the spin axis.

10. A vehicle as claimed in claim 7, wherein the wheels (5) are produced in one or several polymer materials, and further including at least one material suited to affect mechanical properties of the wheel.

11. A vehicle as claimed in claim 7, wherein the wheels (5) have surfaces with patterns arranged to increasing the wheel friction against a pipeline wall.

12. A vehicle as claimed in claim 1, wherein the wheel arms (4) are resilient.

13. A vehicle as claimed in claim 1, further including flexible elements connecting each wheel arm (4) to a hub (3) in said wheel assembly (2a, 2b).

14. A vehicle as claimed in claim 1, further including a quick release mechanism for allowing easy replacement of wheels (5).

15. A vehicle as claimed in claim 1, further including means for adjusting the angle of said spin axis in relation to the chassis.

16. A vehicle as claimed in claim 1, further including a weak link connecting the wheel arms to the wheel assemblies and/or to the wheels.

17. A vehicle as claimed in claim 1, wherein a means for interpolation is included allowing each wheel assembly is controlled individually to allow the vehicle to move according to a predetermined pattern.

18. Vehicle as claimed in claim 17 wherein the vehicle additionally is provided with at least one tool suitable for one or more operations chosen among inspection and maintenance of the pipeline and calibration and repair of equipment located in the pipeline.

19. Method for performing operations within a pipeline, characterised in that a pipeline vehicle according to claim 1 is used as a means therefore.

20. Method as claimed in claim 19 wherein said operations are chosen among inspection and maintenance of the pipeline as well as calibration and repair of instruments or equipment located in the pipeline.
